(19) United States
(12) Patent Application Publication
(10) Pub. No.: US 2025/0065427 A1
(43) Pub. Date: Feb. 27, 2025

(54) Electrical Discharge Machine

(71) Applicant: National Kaohsiung University of Science and Technology, Kaohsiung City (TW)

(72) Inventors: WEN-JENG HSUE, Kaohsiung City (TW); TSUNG-JUI LIN, Kaohsiung City (TW)

(21) Appl. No.: 18/811,748

(22) Filed: Aug. 21, 2024

(30) Foreign Application Priority Data
Aug. 22, 2023 (TW) 112131563

(51) Int. Cl. B23H 1/10; B23H 1/08

(52) U.S. Cl. CPC B23H 1/10; B23H 1/08

(57) ABSTRACT

An electrical discharge machine capable of providing a dielectric droplet and negative pressure suction, driving the dielectric droplet to flow between the EDM tool and the workpiece, allowing the EDM tool to perform nearly-dry electrical discharge machining on the workpiece through the dielectric droplet exerted from the droplet processing cavity. Additionally, the electrical discharge machine can utilize the negative pressure suction to drive debris away from the workpiece through the EDM tool, thereby enhancing debris removal efficiency, preventing the unstable discharge due to accumulation of debris on the workpiece, thereby improving electrical discharge machining efficiency and ensuring that the surface roughness, morphology, and dimensional accuracy of the machined areas of the workpiece meet the expected standards.

### CROSS-REFERENCE TO RELATED APPLICATIONS

This application claims the priority of Republic of China Patent Application No. 112131563 filed on Aug. 22, 2023, in the State Intellectual Property Office of the R.O.C., the disclosure of which is incorporated herein by reference.

### BACKGROUND OF THE INVENTION

### Field of the Invention

The application is related to the technical field of electrical discharge machines (EDM). More specifically, it relates to an electrical discharge machine that can improve the efficiency of debris removal and the contouring quality in the EDM discharge channel.

### Descriptions of the Related Art

Electrical discharge machining (EDM) is a metalworking technology that uses arc discharge in an EDM discharge channel to machine metals, particularly suitable for the precise machining of complex shapes and hard-to-cut conductive materials. When performing deep hole electrical discharge machining, especially for blind holes or micro holes with small diameter, debris often accumulates in the EDM discharge channel and cannot be effectively removed, enabling short circuits and abnormal discharges in the EDM discharge channel, leading to poor EDM efficiency, as well as suboptimal roughness, morphology, and dimensional accuracy of the machined areas of the workpiece.

In view of this, this case provides an electrical discharge machine and its tool to improve the debris removal efficiency in the EDM discharge channel, addressing the technical issues caused by debris accumulation in the EDM discharge channel.

### SUMMARY OF THE INVENTION

In view of the drawbacks of the prior art mentioned above, the present application provides an electrical discharge machine, enabling to be equipped with a dielectric fluid to perform electrical discharge machining on a workpiece, and the electrical discharge machine comprising: a droplet processing cavity, providing a processing dielectric environment for the workpiece and comprising a cavity tool channel; an atomization device, receiving the dielectric fluid and atomizes the dielectric fluid to generate a dielectric droplet, and the atomization device is connected to the droplet processing cavity to provide the dielectric droplet to the processing dielectric environment; an EDM tool, comprising a tool body, a tool machining structure, and a tool inner flow channel, and the tool machining structure is located on the outside of the tool body, and the tool inner flow channel is located inside the tool body and extends through the tool body; an EDM spindle used to install the EDM tool, allowing the EDM tool to enter the droplet processing cavity through the cavity tool channel, and the EDM spindle can also move the EDM tool to bring it close to the workpiece within the droplet processing cavity, forming an EDM discharge channel between the tool machining structure and the workpiece; and a negative pressure providing module connected to the tool inner flow channel, allowing the negative pressure providing module be able to provide negative pressure suction through the tool inner flow channel to create a negative pressure flow field in the EDM discharge channel, forming the fluid driving the dielectric droplet via the negative pressure flow field, thereby driving the dielectric droplet into the EDM discharge channel, allowing the tool machining structure to perform electrical discharge machining on the workpiece in the EDM discharge channel, and then the negative pressure flow field can drive the dielectric droplet out of the EDM discharge channel through the tool inner flow channel.

Preferably, the electrical discharge machine said above, wherein the tool machining structure generates a debris in the EDM discharge channel when the tool machining structure performs electrical discharge machining on the workpiece, and the negative pressure flow field can also drive the debris, driving the debris out of the EDM discharge channel through the tool inner flow channel.

Preferably, the electrical discharge machine said above, further comprising a positive pressure providing module connected to the droplet processing cavity, allowing the positive pressure providing module to provide a positive pressure gas, which is as known as compression pressure gas, to the processing dielectric environment to form a positive pressure flow field in the processing dielectric environment, thereby driving the dielectric droplet to flow within the processing dielectric environment; the droplet processing cavity also comprises a cavity inner flow channel connected to the positive pressure providing module, enabling to provide the positive pressure gas to the cavity inner flow channel, and the cavity inner flow channel extends toward the EDM discharge channel, allowing the positive pressure gas to flow toward the EDM discharge channel, additionally, the cavity inner flow channel is around the tool body, enabling the positive pressure gas to flow around the tool body.

Preferably, the electrical discharge machine said above, wherein the positive pressure gas PG can be oxygen, nitrogen, carbon dioxide, or inert gas.

Preferably, the electrical discharge machine said above, wherein the droplet processing cavity comprises at least a cavity wall, the cavity wall surrounds the processing dielectric environment, and the atomization device is located on the cavity wall; the droplet processing cavity also comprises a cavity droplet guiding structure connecting to the atomization device to receive the dielectric droplet, and the cavity droplet guiding structure extends through the cavity wall toward the EDM discharge channel to guide the dielectric droplet to flow toward the EDM discharge channel; also comprising a liquid container providing the accommodation of the dielectric fluid, and the liquid container is located near the droplet processing cavity, providing the dielectric fluid to the atomization device, and the cavity wall separates the liquid container from the processing dielectric environment.

Preferably, the electrical discharge machine said above, wherein the cavity wall is inclined, directing the cavity droplet guiding structure toward the EDM discharge channel; and the cavity wall comprises a plurality of walls, with adjacent walls connected with each other to allow the shape of the droplet processing cavity to be a conical shape, and the cavity droplet guiding structure is arranged on these cavity walls, directing the cavity droplet guiding structure toward the EDM discharge channel.

Compared to prior art, the present application provides an electrical discharge machine capable of providing a dielectric droplet and negative pressure suction, driving the dielectric droplet to flow between the EDM tool and the workpiece, allowing the EDM tool to perform nearly dry electrical discharge machining on the workpiece through the dielectric droplet. Additionally, the electrical discharge machine can utilize the negative pressure suction to drive debris away from the workpiece through the EDM tool, thereby enhancing debris removal efficiency, preventing the unstable discharge due to accumulation of debris on the workpiece, thereby improving electrical discharge machining efficiency and ensuring that the surface roughness, morphology, and dimensional accuracy of the machined areas of the workpiece meet the expected standards.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic diagram illustrating the usage state of the electrical discharge machine according to the present application.

FIG. 2 is a schematic diagram illustrating the usage state of the electrical discharge machine according to the present application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

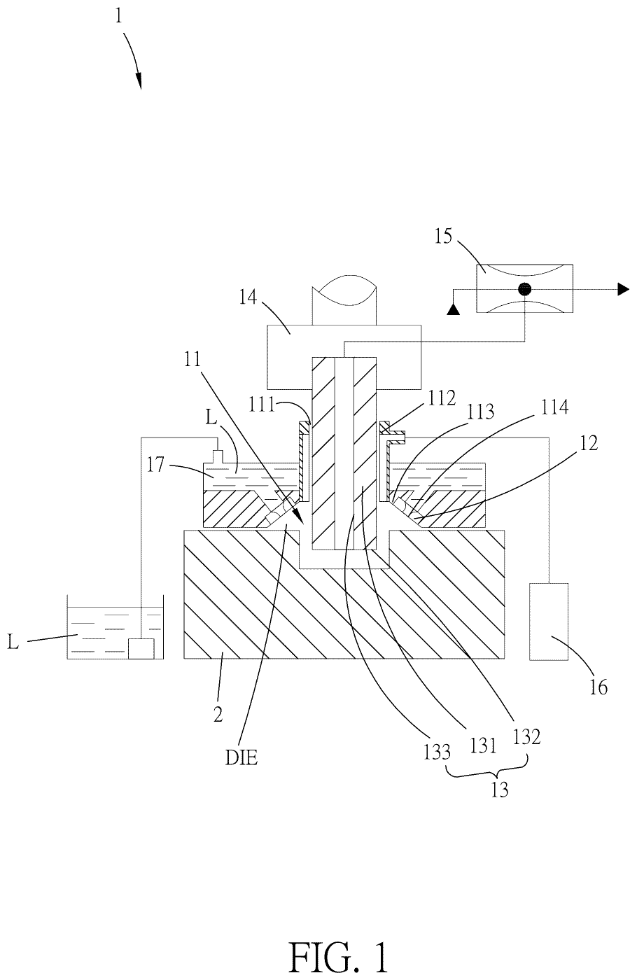

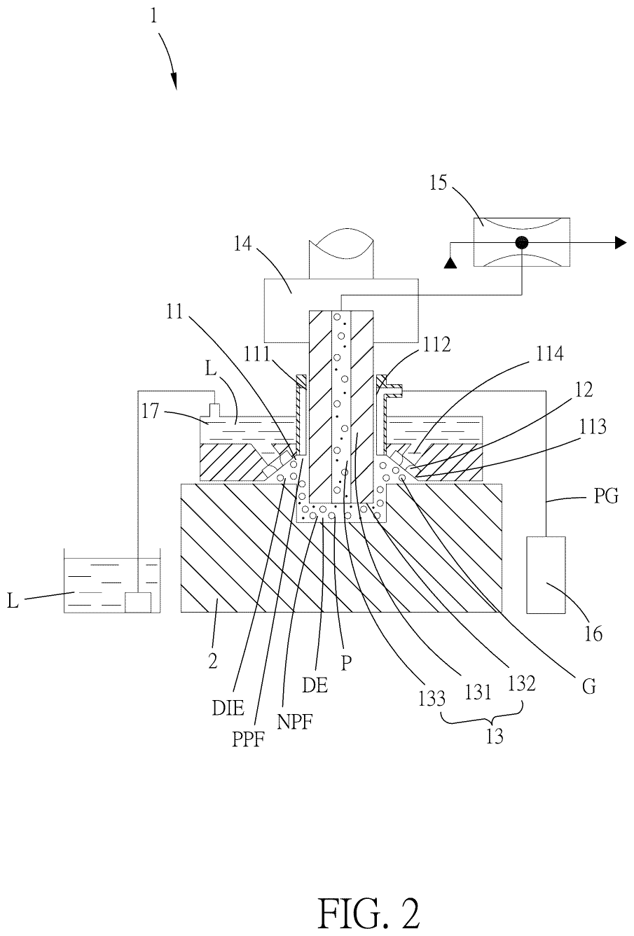

For a detailed description of the embodiments disclosed in the present application, please refer to FIGS. 1 to 2.

As shown in the embodiment in FIG. 2, this application provides an electrical discharge machine 1. The electrical discharge machine 1 can be equipped with a dielectric fluid L, such as ionized water or kerosene, to perform electrical discharge machining on a workpiece 2. The electrical discharge machine 1 comprises a droplet processing cavity 11, an atomization device 12, an EDM tool 13, an EDM spindle 14, and a negative pressure providing module 15. The droplet processing cavity 11 provides a machining dielectric environment (DIE) for the workpiece 2 and comprises a cavity tool channel 111. The atomization device 12 can receive the dielectric fluid L and atomize the dielectric fluid L to produce dielectric droplet G. The atomization device 12 is connected to the droplet processing cavity 11 and can provide the dielectric droplet G to the machining dielectric environment DIE.

It should be noted that the atomization device 12 primarily provides energy through electromagnetic or mechanical forces to atomize the dielectric fluid L, dispersing the dielectric fluid L into very small droplets, thereby transforming the dielectric fluid L into a dielectric droplet G. Optionally, the atomization device 12 can be an ultrasonic vibration device that uses high-frequency vibrations to disperse the dielectric fluid L into the dielectric droplet G.

In the aforementioned embodiment, the EDM tool 13 comprises a tool body 131, a tool machining structure 132, and a tool inner flow channel 133. The tool machining structure 132 is installed on the exterior of the tool body 131. The tool inner flow channel 133 is installed inside the tool body 131 and extends through the tool body 131.

The EDM spindle 14 is used to mount the EDM tool 13, allowing the EDM tool 13 to pass through the cavity tool channel 111 and enter the droplet processing cavity 11. The EDM spindle 14 can also move the EDM tool 13 closer to the workpiece 2 within the droplet processing cavity 11, forming an EDM discharge channel P between the tool machining structure 132 and the workpiece 2. It should be noted that the EDM discharge channel P is the gap located at the end or sidewall of the EDM tool 13 and the workpiece 2, enabling the tool machining structure 132 to perform electrical discharge machining on the workpiece 2 within the EDM discharge channel P. The Droplet Processing Cavity 11 can provide the dielectric droplet G to the EDM Discharge Channel P.

The droplet processing cavity 11 comprises at least a cavity wall 113 and a cavity droplet guiding structure 114. The cavity wall 113 surrounds the machining dielectric environment DIE, and the atomization device 12 is installed on the cavity wall 113. The cavity droplet guiding structure 114 is connected to the atomization device 12 to receive the dielectric droplet G, and the cavity droplet guiding structure 114 extends through the cavity wall 113 and turns toward the EDM discharge channel P, directing the dielectric droplet G to flow toward the EDM discharge channel P. The electrical discharge machine 1 also comprises a liquid container 17, providing storage of the dielectric fluid L, and the liquid container 17 is located adjacent to the droplet processing cavity 11, providing the atomization device 12 with dielectric fluid L. The cavity wall 113 separates the liquid container 17 from the machining dielectric environment DIE, preventing the dielectric fluid L in the liquid container 17 from directly flowing into the machining dielectric environment DIE.

Optionally, the cavity wall 113 is inclined so that the cavity droplet guiding structure 114 is oriented toward the EDM discharge channel P. As shown in the embodiment in FIG. 2, there are a plurality of cavity walls 113, and pair of adjacent cavity walls 113 are connected to allow the shape of the droplet processing cavity 11 is a conical shape. In aforementioned embodiment, the cavity droplet guiding structure 114 is arranged on the cavity walls 113, directing the dielectric droplet G toward the EDM discharge channel P.

The negative pressure providing module 15 is connected to the tool inner flow channel 133, allowing the negative pressure providing module 15 to provide negative pressure through the tool inner flow channel 133 to the EDM discharge channel P, forming a negative pressure flow field NPF in the EDM discharge channel P. The negative pressure flow field NPF drives the dielectric droplet G in the machining dielectric environment DIE to flow into the EDM discharge channel P, enabling the tool machining structure 132 to perform nearly-dry electrical discharge machining on the workpiece 2 with the dielectric droplet G in the EDM discharge channel P. Subsequently, the negative pressure flow field NPF directs the dielectric droplet G to exit the EDM discharge channel P through the tool inner flow channel 133.

It should be noted that the tool machining structure 132 generates debris DE in the EDM discharge channel P during the electrical discharge machining of the workpiece 2. The negative pressure flow field NPF also forms a fluid that drives the debris DE, guiding he debris DE out of the EDM discharge channel P through the tool inner flow channel 133. The electrical discharge machine 1 can provide negative pressure through the tool inner flow channel 133 to remove the debris DE from the EDM discharge channel P, thereby improving the efficiency of debris DE removal from the EDM discharge channel P.

As shown in the embodiment in FIG. 2, the electrical discharge machine 1 also comprises a positive pressure providing module 16. The positive pressure providing module 16 is connected to the droplet processing cavity 11, enabling the positive pressure providing module 16 to provide positive pressure gas PG to the machining dielectric environment DIE to mix the positive pressure gas PG and the dielectric droplet G, forming a positive pressure flow field PPF within the machining dielectric environment DIE. The positive pressure flow field PPF drives the dielectric droplet G to flow within the machining dielectric environment DIE. The positive pressure gas PG can be oxygen, nitrogen, carbon dioxide, or inert gas, wherein the inert gas comprises helium and argon.

In the aforementioned embodiment, the droplet processing cavity 11 also comprises a cavity inner flow channel 112, and the positive pressure providing module 16 is connected to the cavity inner flow channel 112. The positive pressure providing module 16 provides positive pressure gas PG, such as an inert gas like argon or oxygen, to the cavity inner flow channel 112. The cavity inner flow channel 112 extends toward the EDM discharge channel P, allowing the positive pressure gas PG to flow through the cavity inner flow channel 112 into the EDM discharge channel P, driving the dielectric droplet G to flow into the EDM discharge channel P through positive pressure flushing, enabling the EDM tool 13 to perform nearly-dry electrical discharge machining on the workpiece 2 with the dielectric droplet G. Additionally, the positive pressure gas PG forms a fluid that drives the debris DE, driving the debris DE out of the EDM discharge channel P through the tool inner flow channel 133 with the aid of positive pressure flushing. Optionally, the cavity inner flow channel 112 surrounds the tool body 131, allowing the positive pressure gas PG to flow around the tool body 131 and into the EDM discharge channel P, removing the debris DE from the EDM discharge channel P through positive pressure flushing, improving the efficiency of debris DE removal from the EDM discharge channel P.

It should be noted that in the above embodiments, some components can be omitted. For example, in this application, the electrical discharge machine comprises a droplet processing cavity, an atomization device, an EDM tool, an EDM spindle, and a negative pressure providing module. The droplet processing cavity provides a dielectric environment for the workpiece and is equipped with a cavity tool channel. The atomization device receives the dielectric fluid, atomizes the dielectric fluid to generate a dielectric droplet, and connects to the droplet processing cavity, providing the dielectric droplet to the dielectric environment. The EDM tool comprises a tool body, a tool machining structure, and a tool inner flow channel. The tool machining structure is installed on the exterior of the tool body, while the tool inner flow channel is installed inside the tool body and extends through the tool body. The EDM spindle is used to mount the EDM tool, allowing the EDM tool to pass through the cavity tool channel into the droplet processing cavity. The spindle can also move the EDM tool closer to the workpiece within the cavity, forming an EDM discharge channel between the tool machining structure and the workpiece. The negative pressure providing module connects to the tool inner flow channel, enabling the negative pressure providing module to provide negative pressure suction through the tool inner flow channel to the EDM discharge channel, forming a negative pressure flow field in the EDM discharge channel, forming a fluid driving the dielectric droplet via the negative pressure flow field, driving the dielectric droplet in the machining dielectric environment to flow into the EDM discharge channel, allowing the tool machining structure to perform electrical discharge machining on the workpiece in the EDM discharge channel. Subsequently, the negative pressure flow field also drives the dielectric droplet to exit the EDM discharge channel through the tool inner flow channel.

In summary, this application provides an electrical discharge machine capable of performing electrical discharge machining on a workpiece with the dielectric fluid. The machine comprises a droplet processing cavity, an atomization device, an EDM tool, an EDM spindle, and a negative pressure providing module. The droplet processing cavity provides a machining dielectric environment for the workpiece. The atomization device atomizes the dielectric fluid, providing a dielectric droplet to the dielectric environment. The EDM tool comprises a tool machining structure and a tool inner flow channel. The EDM spindle can move the EDM tool closer to the workpiece within the droplet processing cavity, forming an EDM discharge channel between the tool machining structure and the workpiece. The negative pressure providing module can provide negative pressure through the tool inner flow channel to the EDM discharge channel, driving the dielectric droplet to flow into the EDM discharge channel, allowing the tool machining structure to perform electrical discharge machining on the workpiece within the EDM discharge channel. The negative pressure also facilitates the removal of debris from the EDM discharge channel through the tool inner flow channel, improving the efficiency of debris removal and enhancing the morphology, dimensional accuracy, and surface roughness of the workpiece.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical discharge machine, enabling to be equipped with a dielectric fluid to perform electrical discharge machining on a workpiece, and the electrical discharge machine comprising:
a droplet processing cavity, providing a processing dielectric environment for the workpiece and comprising a cavity tool channel;
an atomization device, receiving the dielectric fluid and atomizes the dielectric fluid to generate a dielectric droplet, and the atomization device is connected to the droplet processing cavity to provide the dielectric droplet to the processing dielectric environment;
an EDM tool, comprising a tool body, a tool machining structure, and a tool inner flow channel, and the tool machining structure is located on the outside of the tool body, and the tool inner flow channel is located inside the tool body and extends through the tool body;
an EDM spindle used to install the EDM tool, allowing the EDM tool to enter the droplet processing cavity through the cavity tool channel, and the EDM spindle can also move the EDM tool to bring it close to the workpiece within the droplet processing cavity, forming an EDM discharge channel between the tool machining structure and the workpiece; and
a negative pressure providing module connected to the tool inner flow channel, allowing the negative pressure providing module be able to provide negative pressure suction through the tool inner flow channel to create a negative pressure flow field in the EDM discharge channel, forming the fluid driving the dielectric droplet via the negative pressure flow field, thereby driving the dielectric droplet into the EDM discharge channel, allowing the tool machining structure to perform electrical discharge machining on the workpiece in the EDM discharge channel, and then the negative pressure flow field can drive the dielectric droplet out of the EDM discharge channel through the tool inner flow channel.

2. The electrical discharge machine of claim 1, wherein the tool machining structure generates a debris in the EDM discharge channel when the tool machining structure performs electrical discharge machining on the workpiece, and the negative pressure flow field can also drive the debris, driving the debris out of the EDM discharge channel through the tool inner flow channel.

3. The electrical discharge machine of claim 1, further comprising a positive pressure providing module connected to the droplet processing cavity, allowing the positive pressure providing module to provide a positive pressure gas to the processing dielectric environment to form a positive pressure flow field in the processing dielectric environment, thereby driving the dielectric droplet to flow within the processing dielectric environment; the droplet processing cavity also comprises a cavity inner flow channel connected to the positive pressure providing module, enabling to provide the positive pressure gas to the cavity inner flow channel, and the cavity inner flow channel extends toward the EDM discharge channel, allowing the positive pressure gas to flow toward the EDM discharge channel, additionally, the cavity inner flow channel is around the tool body, enabling the positive pressure gas to flow around the tool body.

4. The electrical discharge machine of claim 3, wherein the positive pressure gas PG can be oxygen, nitrogen, carbon dioxide, or inert gas.

5. The electrical discharge machine of claim 1, wherein the droplet processing cavity comprises at least a cavity wall, the cavity wall surrounds the processing dielectric environment, and the atomization device is located on the cavity wall; the droplet processing cavity also comprises a cavity droplet guiding structure connecting to the atomization device to receive the dielectric droplet, and the cavity droplet guiding structure extends through the cavity wall toward the EDM discharge channel to guide the dielectric droplet to flow toward the EDM discharge channel; also comprising a liquid container providing the accommodation of the dielectric fluid, and the liquid container is located near the droplet processing cavity, providing the dielectric fluid to the atomization device, and the cavity wall separates the liquid container from the processing dielectric environment.

6. The electrical discharge machine of claim 4, wherein the cavity wall is inclined, directing the cavity droplet guiding structure toward the EDM discharge channel; and the cavity wall comprises a plurality of walls, with adjacent walls connected with each other to allow the shape of the droplet processing cavity to be a conical shape, and the cavity droplet guiding structure is arranged on the cavity walls, directing the cavity droplet guiding structure toward the EDM discharge channel.
